(19) United States
(12) Patent Application Publication
(10) Pub. No.: US 2009/0101731 A1
(43) Pub. Date: Apr. 23, 2009

(54) Rotating Nozzle And Rotating Nozzle Device For Dispensing Pressurized Fluids

(76) Inventor: Tiziano Redaelli, Fiesco (IT)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/225,037

(22) PCT Filed: Jun. 9, 2006
(86) PCT No.: PCT/IB2006/001643

§ 371 Date: Sep. 12, 2008

(30) Foreign Application Priority Data
Mar. 14, 2006 (IT) MI2006A000452

(51) Int. Cl. B05B 3/02; B05B 9/04; B05B 11/00; B65D 83/16

(52) U.S. Cl. 239/251; 239/263.3; 239/329; 239/337; 239/537

(57) ABSTRACT

Rotating nozzle for dispensing pressurised fluids contained in a spray can (1) provided with a dispensing valve (2) which can be actuated in the axial direction (X-X) for opening/closing thereof, said nozzle comprising a front dispensing part (260) movable rotationally and axially fixed to a part (230) for coupling with the spray can (1), said coupling part being in turn movable in terms of displacement and idle rotationally.

The present invention relates to a rotating nozzle and a rotating nozzle device for dispensing fluids contained in pressurised containers.

According to the state of the art spray cans are known inside which a fluid partially in a gaseous state is stored so as to produce a pressure and form a propellant which allows dispensing of the fluid by means of dispensing nozzles mounted on the spray can.

It is also known that said dispensing means are able to emit a directional jet of fluid and that there is instead a need for emission of the fluid in variable directions within the space so as to increase the spatial distribution effect of the fluid emitted.

This need is greater in the case of those fluids which solidify during emission, producing string-like and/or streamer effects.

The technical problem which is posed, therefore, is to provide a fluid dispensing device which is able to emit a fluid in variable directions.

In connection with this problem it is also required that this device should have small dimensions, be easy and inexpensive to manufacture and suitable for use also by non-expert end users.

These results are achieved according to the present invention by a rotating nozzle for dispensing pressurised fluids according to the characteristic features of claim 1 and a rotating nozzle device for dispensing pressurised fluids according to the characteristic features of claim 9.

Further details may be obtained from the following description of a non-limiting example of embodiment of the object of the present invention, provided with reference to the accompanying drawings in which:

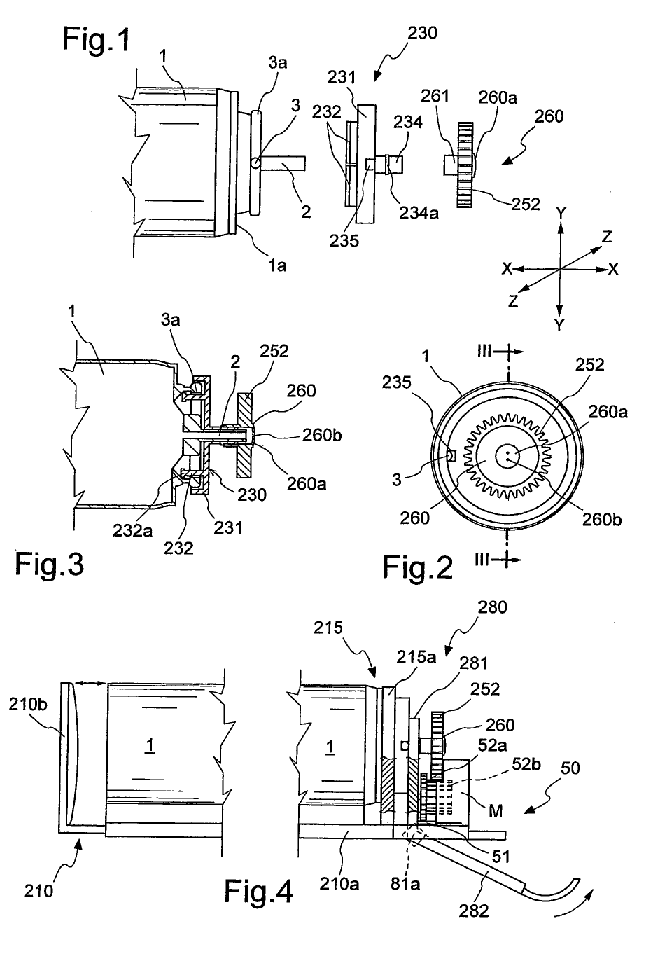

FIG. 1 shows an exploded side view of a first embodiment of the rotating nozzle according to the present invention;

FIG. 2 shows a front end view of the rotating nozzle according to FIG. 1, mounted on the spray can;

FIG. 3 shows a schematic cross-sectional view along the plane indicated by III-III in FIG. 2;

FIG. 4 shows a partially sectioned schematic side view of a first embodiment of the rotating nozzle dispensing device according to the present invention;

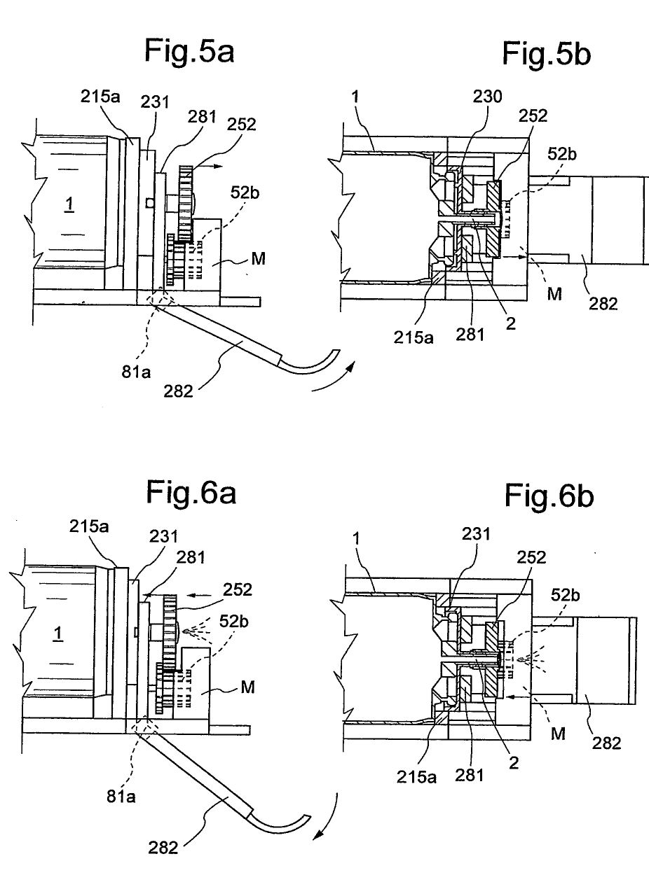

FIGS. 5a,5b show a side view and a schematic cross-section, along a longitudinal plane, of the device according to FIG. 4 in the rest condition;

FIGS. 6a,6b shows a side view and a schematic cross-section, similar to those of FIGS. 5a,5b, of the device during dispensing;

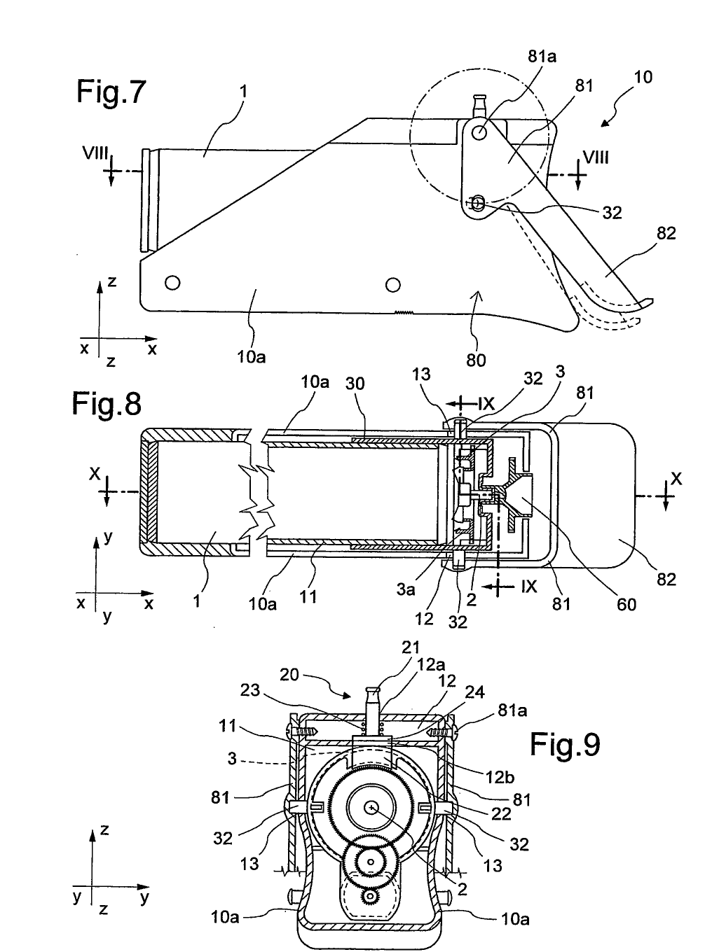

FIG. 7 shows a side view of a second embodiment of the dispensing device according to the present invention;

FIG. 8 shows a cross-section along the plane indicated by VIII-III in FIG. 7;

FIG. 9 shows a schematic cross-section along the plane indicated by IX-IX in FIG. 8;

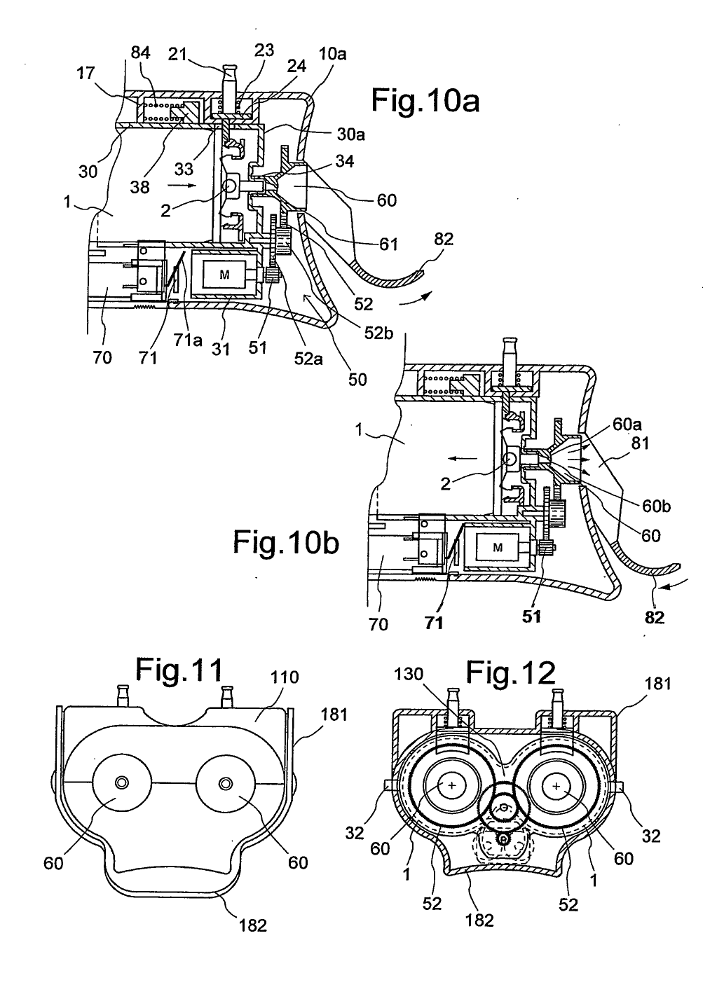

FIGS. 10a,10b show a schematic cross-section, along the plane indicated by X-X in FIG. 8, of the device in the rest condition and dispensing condition, respectively;

FIG. 11 shows a front view of a further embodiment of the device according to the present invention;

FIG. 12 shows a partially sectioned, schematic, front view of the device according to FIG. 11;

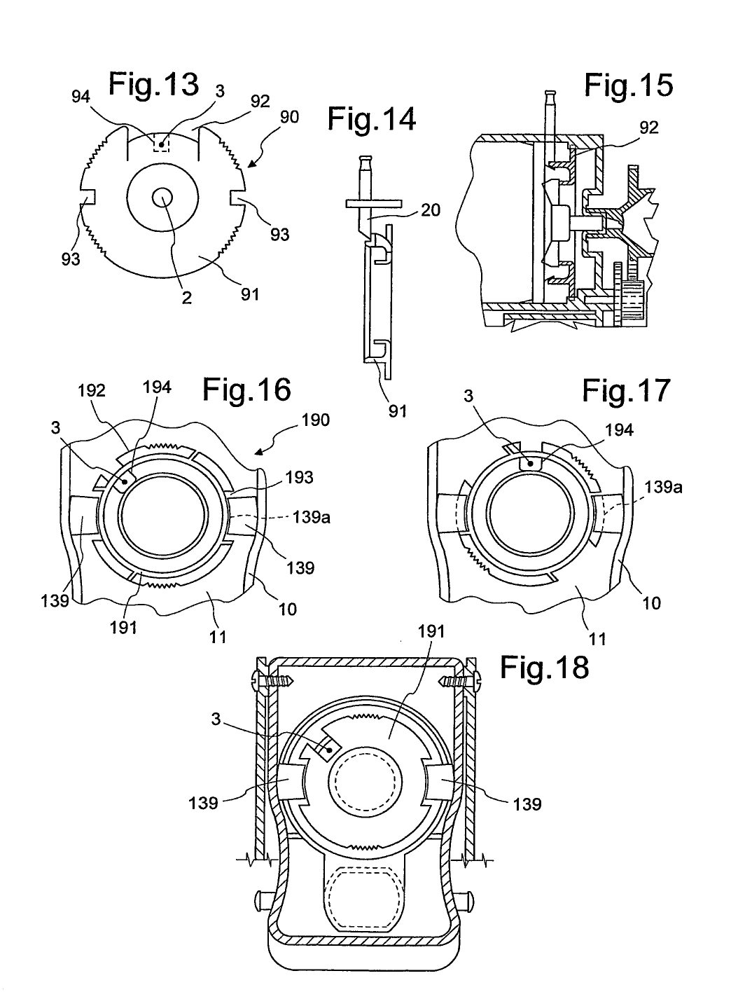

FIG. 13 shows a front view of an auxiliary coupling part for the device according to the present invention;

FIG. 14 shows a detail of the axial connection between the spray can and the device according to FIG. 13;

FIG. 15 shows a partial schematic cross-sectional view of the device according to the present invention with the coupling part according to FIG. 13;

FIG. 16 shows a front view of a second embodiment of a coupling part of the device according to the present invention;

FIG. 17 shows a cross-sectional front view of the device according to the present invention with the coupling part according to FIG. 16 during insertion; and

FIG. 18 shows a partial view, similar to that of FIG. 17, with the coupling part in the locking position.

As shown in FIGS. 1-3 and assuming solely for the sake of convenience of the description and in a non-limiting manner a set of three reference axes in the longitudinal direction X-X, transverse direction Y-Y and vertical direction Z-Z, respectively, as well as a front part corresponding to dispensing of the fluid and a rear part opposite to the front part in the longitudinal direction, the rotating nozzle 260 according to the invention may be mounted on a spray can 1 provided with an associated dispensing valve 2 which can be actuated in the axial direction for opening/closing thereof according to the conventional art; said nozzle 260 comprises a rear shank 261 which is internally hollow and closed at the front by a front surface 260a in which at least one dispensing hole 260b arranged axially offset with respect to the longitudinal axis of the said nozzle is formed.

The nozzle 260 has a crown gear 252 which is coaxial and able to engage with a kinematic actuating chain 50, as will emerge more clearly below.

The rear shank 261 of the nozzle has an outer diameter slightly greater than a ring 234a radially projecting from a hollow sleeve 234 coaxially extending towards the front of a middle part 230 for coupling together the nozzle 260 and can 1.

In greater detail, said middle coupling part 230 is formed by a circumferential capsule 231 having, coaxially arranged inside it, flanges 232 which are elastically deformable in the radial direction and have a respective raised edge 232a able to engage by means of an undercut with the rim 3a for sealing the valve 2 to the spray can 1.

As shown in FIG. 2, the nozzle is keyed by means of its rear shank 261 onto the front sleeve 234 of the coupling part to which it is constrained by means of interference with the circular ring 234a with which it also ensures a fluid-tight seal in addition to mechanical retention in the axial direction.

The assembly thus assembled is then axially mounted on the spray can 1 by means of engagement of the raised edges 232a of the flanges 232 of the coupling part 230 with the edge 3a of the said spray can.

According to a preferred embodiment of the nozzle, it is envisaged that the capsule 231 of the coupling part 230 is provided with an opening 294 which allows the user to see a reference notch 3 formed on the edge 3a of the spray can 1 and able to produce orientation of the spray can with respect to its internal draw-off (not shown), resulting in correct angular orientation of the spray can in such a way that it is oriented, for correct use thereof, with its draw-off directed downwards so as to ensure removal of the largest possible amount of fluid contained in the spray can.

As shown in FIG. 4, the spray can 1 is inserted inside a dispensing device 210 able to actuate rotationally the nozzle 260 upon operation by the user.

Said device comprises a container body 210 formed by a base 210a and a rear sliding piece 210b able to be displaced outwards/inwards so as to lock/unlock the spray can 1 in the axial direction and allow insertion/extraction thereof inside the associated seat.

Said seat is limited at the front by a first fixed fork member 215 and by a second fork member 280 displaceable in either sense in the longitudinal direction.

The relative distance between the arms 215a and 281 of the two fork members is such as to cause insertion of the former up against the front edge 1a of the spray can 1 and of the latter against the front surface of the coupling part 230.

The displacement of the movable fork member 280 towards the rear of the device is performed by means of a lever 282 which is hinged on the movable fork member 280 by means of a connection 281 which is conventional per se and therefore not shown in detail, such as to cause retraction of the coupling body following a rotation in the clockwise direction of the operating lever 282.

The return travel movement of the fork member is instead produced by the internal pressure of the spray can.

As shown also with reference to the following figures in which appropriate reference numbers have been used for the various embodiments of the different parts, the rotation of the nozzle 260 is produced by a kinematic chain 50 comprising a first gearwheel 52a engaging with a pinion 51 rotationally integral with the shaft of an actuating motor M and a second gearwheel 52b engaging with said crown gear 252 of the nozzle 260.

The transmission ratios of the kinematic chain are such as to cause a rotation of the nozzle 260 with a minimum resistance to rotation, suitable for allowing smaller dimensions of the motor M and therefore a smaller power consumption of the power supply batteries 70 which may in this way have an adequate duration over time.

As described in detail for the further embodiments shown in FIGS. 5a-7 to which reference will be made, a switch 71 is situated between the motor M and the batteries 70, the closing lever 71a thereof being arranged along the displacement path of the movable fork member 280.

With the configurations of the nozzle 260 and dispensing device 210 described above, operation of the dispensing system is as follows:
the coupling part 230 already attached to the nozzle 260 is mounted on the spray can 1;
in this way the valve 2 of the spray can is inserted in the sleeve 234 on which the nozzle 260 is already mounted;
the spray can 1 is inserted inside the corresponding seat of the container 210 until locking thereof in the axial direction is obtained, caused by the sliding piece 210b coming into contact against the said spray can;
in these conditions the nozzle 260 is arranged against the arms 281 of the fork member 280 (FIGS. 5a,5b);
the lever 282 is operated (FIGS. 6a,6b), causing it to rotate towards the rear of the device so as to cause a corresponding displacement of the fork member 280 and therefore the coupling part 230; said displacement causes:
pushing, in the axial direction, of the part 230 against the valve 2 of the spray can which, opening, causes the fluid contained inside it to emerge;
operation of the lever 71a of the switch 71 which, closing, energizes the motor M, causing rotation of the pinion 51, actuates the kinematic chain 52,53,54 which, acting on the crown gear 252, causes rotation of the nozzle 260 which, interacting with the thrusting force, in the longitudinal direction, of the fluid emerging from the can, causes dispensing thereof with a helical spatial progression, this effect being particularly effective in the case of fluids which, upon leaving the spray can, solidify rapidly, producing a string-like or streamer effect.
when the lever 282 is released, the pressure of the spray can causes the forwards displacement of the coupling part 230 and therefore the nozzle 260 with consequent closing of the valve 2, release of the switch 71 and switching-off of the motor M, preparing the device so that it is ready for dispensing again.

As shown in FIG. 7, in a second embodiment of the dispensing device according to the present invention, said device consists of a container body 10 which is formed by two half-shells 10a joined together in the transverse direction and formed so as to define an inner seat 11 extending in the longitudinal direction X-X for insertion and stable fixing of a spray can 1 provided with an associated dispensing valve 2 which can be actuated in the axial direction for opening/closing thereof in a conventional manner.

In order to be able to allow correct angular orientation of the spray can as regards the internal draw-off, said can is provided with a reference notch 3 which is visible from the outside and normally arranged on the front collar 3a of the can.

The container body 10 has, on its upper surface according to the orientation of the figures, a seat 12 which opens outwards via a hole 12a and inwards via an eyelet 12b, these being able to allow, respectively, the insertion of an operating pin 21 and a ratchet 22 forming part of a locking device 20 pushed in the radial direction towards the spray can 1 by a spring 23 arranged between a thrust washer 24 of the locking device 20 and the upper wall of the seat 12.

The body 10 has, seated inside it, a bell piece 30 which extends in the longitudinal direction and which has, integral therewith, a seat 31 housing a motor M for actuating a pinion 51 rotationally fixed to the motor shaft. The side surface of the bell piece 30 has, extending from it, in the transverse direction Y-Y, two pins 32 arranged in a diametrically opposite position and projecting outside of the half-shells 10a of the container 10 through two respective eyelets 13, said eyelets extending parallel to the longitudinal axis X-X and being able to allow a displacement of the two pins 32 and therefore the bell piece 30 in both senses of the longitudinal direction X-X.

Said bell piece 30 also has an additional eyelet 33 of suitable width in the longitudinal direction, able to allow the insertion, in the radial direction, of the ratchet 22 of the locking device 20 as well as the displacement, in the axial direction, of the bell piece 30 with respect thereto.

A hollow sleeve 34 extends coaxially from the front surface 30a of the bell piece 30 and has, keyed thereon, the rear shank 61 of a nozzle 60 which is shaped substantially in the form of a funnel and the end wall 60a of the funnel has, formed therein, at least one dispensing hole 60b axially offset with respect to the longitudinal axis of the nozzle.

The nozzle 60 supports a coaxial crown gear 52 which can be rotationally operated by means of a kinematic chain 50 made to rotate by the pinion 51 and comprising a first gearwheel 52a engaging with said pinion 51 and a second gearwheel 52b engaging with said crown gear 52, which gearwheels are coaxial with each other and integral with the bell piece 30.

The transmission ratios of the kinematic chain are such as to cause a rotation of the nozzle 60 with a minimum resistance to rotation, suitable for allowing smaller dimensions of the motor M and therefore a smaller power consumption of the power supply batteries 70 which may in this way have an adequate duration over time.

The two outwardly projecting pins 32 of the bell piece 30 are able to engage with the arms 81 of a fork member 80 which is constrained to the container 10 by means of screws 81a which form the fixed pivots about which the fork member can rotate when rotationally actuated by the user operating the corresponding lever 82 extending towards the front of the device.

In this way the rotation of the fork member 80 about the fixed pivots 81a causes the displacement of the bell piece 30 towards the rear of the device.

Said displacement takes place against the thrusting action exerted on a tooth 38 of the bell piece 30 by a spring 84 which reacts against an associated stop surface 17 of the container 10.

Said batteries 70 are connected to the motor M via a switch 71, the closing lever 71a of which is arranged on the displacement path of the bell piece 30.

With this structure, operation of the device occurs as follows:
the spray can 1 is inserted inside the corresponding seat 11 of the container 10 until locking thereof in the axial direction is obtained, caused by interaction, in the radial direction, of the locking means 20 with the collar 3a of the said spray can;
in this way the valve 2 of the spray can is situated opposite the shank 61 of the bell piece 30;
the lever 82 is operated (FIG. 10b), causing it to rotate towards the rear part so as to cause the rotation thereof about the fixed pins 81a and therefore the displacement towards the rear of the bell piece 30; said displacement causes:
pushing, in the axial direction, of the nozzle 60 against the valve 2 of the spray can which, opening, causes the fluid contained inside it to emerge;
operation of the lever 71a of the switch 71 which, closing, energizes the motor M which, causing rotation of the pinion 51, actuates the kinematic chain 52,53,54 which causes rotation of the nozzle 60, rotation of which, interacting with the thrusting force, in the longitudinal direction, of the fluid emerging from the can, causes dispensing thereof with a helical spatial progression, this effect being particularly effective in the particular case of fluids which, upon leaving the spray can, solidify rapidly, producing a string-like or streamer effect.

FIGS. 11-12 show a further variation of embodiment of the device according to the present invention which has inside a container 110 two seats 11 for housing two spray cans 1 arranged alongside each other and inserted inside a single bell piece 130, in turn having enlarged dimensions so as to contain two spray cans 1 and having two nozzles 60 with a respective crown gear 52 moved by the same kinematic chain 50, already described, which in this case is arranged centrally with respect to the two nozzles 60.

The bell piece 130 is again actuated displaceably by the lever 182 acting by means of the arms 181 on the pins 32 integral with the bell piece 130; with this configuration it is possible to dispense two fluids, independently of each other, for example having a different colour.

FIGS. 13 to 14 also show a part 90 for relative coupling together of the spray can 1 and the bell piece 30; 130 of the device and substantially comprising a ring 91 provided with a first opening 92 able to allow the insertion, in the axial direction, of the locking means 20 of the device and two further seats 93 able to engage with corresponding ribs 39 projecting radially towards the inside of the bell piece 30. In this way the spray can may be inserted inside its seat 11 in a single predefined position determined by engagement of the seats 93 with the ribs 39, resulting in a fixed orientation of the spray can.

This predefined orientation is particularly useful since it is possible to envisage on the ring 91a further opening 94 which allows the user to see the said reference notch 3 for orientation of the spray can with regard to its internal draw-off.

In this way the ring 91 is mounted on the spray can, a relative rotation of the two parts is performed until the window 94 allows one to see the reference notch 3 on the spray can and the can is inserted axially into the seat 11, rotating it until the ribs 39 enter into seats 93 of the ring 91, producing the correct angular orientation of the spray can and allowing completion of its axial insertion inside the seat 11, so that the spray can 1 is angularly oriented for correct use thereof, with its draw-off directed downwards so as to ensure the removal of the largest possible amount of fluid contained inside the spray can.

FIGS. 16, 17, 18 shows a further embodiment of the part 190 for coupling together the spray can 1 and the dispensing device, which envisages, in this case, an engaging system of the bayonet type with a ring 191 having a lowered annular edge 192 interrupted over suitable angular sections forming seats 193 which are open in the axial direction; correspondingly, the ribs 139 of the bell piece 30 have a respective undercut 139a underneath which the annular edge 192 is able to rotate.

In this case also, the coupling part 190 has the window 194 which allows rotation of the ring 191 until the reference notch 3 of the spray can may be seen, producing correct relative orientation of the ring/spray can.

When inserting the spray can axially inside the seat 11 of the container 10 it is possible to obtain complete insertion only with the correct angular orientation of ring 190 and ribs 139 and locking in position by means of rotation of the spray can, said rotation being allowed in a single angular direction so as to determine precisely the correct position of the draw-off with respect to the dispensing device.

It can therefore be seen how with the dispensing device according to the invention it is possible to dispense the jet of fluid with a helical progression able to ensure a greater spatial distribution of the fluid emitted.

This solution is particularly effective for those fluids which solidify upon leaving the spray can, with a string-like or similar form, dispensing of which with a helical progression is also particularly attractive for users from an optical point of view.

1. Nozzle for dispensing pressurised fluids contained in a spray can provided with a dispensing valve which can be actuated in the axial direction for opening/closing thereof, characterized in that it is rotating.

2. Nozzle according to claim 1, characterized in that it comprises a front dispensing part (260) movable rotationally and axially fixed to a part (230) for coupling with the spray can (1) in turn movable in terms of displacement and idle rotationally.

3. Nozzle according to claim 2, characterized in that said front dispensing part (260) comprises a rear shank (261) which is internally hollow and closed at the front by a front surface (260a) having, formed therein, at least one dispensing hole (260b) axially offset with respect to the longitudinal axis of the said nozzle.

4. Nozzle according to claim 2, characterized in that the front part (260) has a coaxial crown gear (252) able to engage with a kinematic chain (50) for rotational actuation.

5. Nozzle according to claim 2, characterized in that said rear hollow shank (261) has an inner diameter slightly greater than the outer diameter of a ring (234a) radially projecting from a hollow sleeve (234) coaxially extending from the front of said coupling part (230).

6. Nozzle according to claim 2, characterized in that said middle coupling part (230) is formed by a circumferential capsule (231) having, coaxially arranged inside it, flanges (232) extending axially and elastically deformable in the radial direction.

7. Nozzle according to claim 6, characterized in that said flanges (232) have a respective raised edge (232a) able to engage by means of an undercut with, corresponding parts (3a) of the spray can.

8. Nozzle according to claim 2, characterized in that the coupling part (230) has, formed therein, an opening (294) able to allow alignment thereof with a reference notch (3) formed in the edge (3a) of the spray can.

9. Device for dispensing pressurised fluids contained in a spray can provided with a dispensing valve able to be actuated in the axial direction for; opening/closing thereof, said device comprising a container body inside which said spray can may be housed, the container body having, associated therewith, means exerting a thrust on the valve in the axial direction so as to cause the opening thereof, characterized in that it comprises:
a rotating dispensing nozzle—means for exerting a thrust, in the axial direction, on the valve of the spray can;
a kinematic chain for transmission of the rotation of the shaft of a motor to the nozzle.

10. Device according to claim 9, characterized in that said nozzle comprises a front dispensing part (260) movable rotationally and axially fixed to a part (230) for coupling with the spray can (1), said coupling part (230) being in turn movable in terms of displacement and idle rotationally.

11. Device according to claim 10, characterized in that said nozzle dispensing part (260) comprises a rear shank (261) which is internally hollow and closed at the front by a front surface (260a) having, formed therein, at least one dispensing hole (260b) axially offset with respect to the longitudinal axis of the said nozzle.

12. Device according to claim 9, characterized in that the nozzle (260) has a coaxial crown gear (252) able to engage with a kinematic chain (50) for rotational actuation.

13. Device according to claim 10, characterized in that the hollow rear shank (261) of the nozzle (260) has an inner diameter slightly greater than the outer diameter of a ring (234a) radially projecting from a hollow sleeve (234) coaxially extending towards the front of said coupling part (230).

14. Nozzle according to claim 1, characterized in that said middle coupling part (230) is formed by a circumferential capsule (231) having, coaxially arranged′ inside it, flanges (232) extending axially and elastically deformable in the radial direction.

15. Device according to claim 1, characterized in that said flanges (232) have a respective raised edge (232a) able to engage by means of an undercut with corresponding parts (3) of the spray can (1).

16. Device according to claim 10, characterized in that the coupling part (230) has, formed therein, an opening (294) able to allow alignment thereof with a reference notch (3) formed in the front edge (3a) of the spray can so as to cause orientation of the spray-can as regards its internal draw-off.

17. Device according to claim 9, characterized in that it comprises a container body (210) formed by a base (210a) with an axial seat (211) and a rear sliding piece (210b) able to displaced outwards/inwards so as to lock/unlock the spray can (1) in the axial direction.

18. Device according to claim 17, characterized in that said axial seat (211) is delimited at the front by a first fixed fork member (215) and by a second more external fork member (280) displaceable in both senses in the longitudinal direction.

19. Device according to claim 18, characterized in that the relative distance between the arms (215a, 281) of the two fork members is such as to cause insertion of the former up against the front edge (Ia) of the spray can and the latter against the front surface of the coupling part (230).

20. Device according to claim 18, characterized in that it comprises a lever (282) for performing displacement of the movable fork member (280) towards the rear of the device.

21-54. (canceled)
